(19) United States
(12) Patent Application Publication
(10) Pub. No.: US 2025/0116580 A1
(43) Pub. Date: Apr. 10, 2025

(54) LABORATORY MILL AND SAMPLE HOLDER FOR A LABORATORY MILL

(71) Applicant: Retsch GmbH, Haan (DE)

(72) Inventor: Zilan Orhan, Hilden (DE)

(73) Assignee: Retsch GmbH, Haan (DE)

(21) Appl. No.: 18/730,118

(22) PCT Filed: Jan. 20, 2023
(86) PCT No.: PCT/EP2023/051362

§ 371 Date: Jul. 18, 2024

(30) Foreign Application Priority Data
Jan. 21, 2022 (DE) 10 2022 101 449.5
Jan. 25, 2022 (DE) 10 2022 101 630.7
Apr. 8, 2022 (DE) 10 2022 108 580.5

(51) Int. Cl. G01N 1/28; B01L 7/00; B01L 9/00

(52) U.S. Cl. CPC G01N 1/286; B01L 7/00; B01L 9/00; B01L 2300/18; G01N 2001/2866

(57) ABSTRACT

A laboratory mill is shown and described with at least one sample holder for receiving at least one sample vessel and with at least one holding device arranged to be rotatable about an axis of rotation and/or to oscillate about an axis of oscillation for holding and carrying along the sample holder during operation of the laboratory mill, wherein the sample vessel is moved on an orbit with an effective radius during operation of the laboratory mill, wherein complementary coupling geometries are provided on the sample holder and the holding device for a positive coupling of the sample holder to the holding device, and wherein the sample holder can be coupled to the holding device via the coupling geometries in at least two different orientations relative to the axis of rotation and/or the axis of oscillation in order to change the effective radius of the orbit of a sample vessel.

### CROSS-REFERENCE TO RELATED APPLICATIONS

The present application is the U.S. national stage application of international application PCT/EP2023/051362, filed Jan. 20, 2023, which international application was published on Jul. 27, 2023, as International Publication WO 2023/139208 A1. The international application claims priority to German Patent Application No. 102022101449.5, filed Jan. 21, 2022; German Patent Application No. 102022101630.7, filed Jan. 25, 2022; and German Patent Application No. 102022108580.5, filed Apr. 8, 2022. The international application and German applications are hereby incorporated by reference herein in their entireties.

### BACKGROUND

The invention relates to a laboratory mill, in particular a laboratory vibrating mill, with at least one sample holder for receiving at least one sample vessel, in particular for receiving a plurality of sample vessels, further in particular for receiving reaction vessels for small sample volumes in the milliliter range, and with at least one holding device, which is arranged to be rotatable about an axis of rotation and/or to oscillate about an axis of oscillation, for holding and carrying along the sample holder during operation of the laboratory mill, in particular a holding device which is connected to a swing arm of the laboratory mill and moves with the swing arm during operation of the mill, wherein the sample vessel is moved during operation of the laboratory mill on an orbit about the axis of rotation and/or swivel axis with an effective radius, in particular wherein the plurality of sample vessels are moved on orbits with different effective radii.

Furthermore, the invention relates to a sample holder for a laboratory mill of the aforementioned type.

A laboratory mill of the aforementioned type is already known from DE 10 2020 101 523 A1. The known laboratory mill is a vibrating mill for two grinding bowls as sample holders that perform circular arc-shaped vibrations in a horizontal position. A pendulum drive of the vibrating mill has a multi-part design with an eccentric shaft mounted to rotate about a vertical eccentric axis and with two swing arms each mounted to vibrate about vertical vibration axes and connected to the eccentric shaft via couplings. Grinding bowl holders for the grinding bowls are attached to the swing arms. Each grinding bowl holder has a cooling plate as a heat transfer element, which is connected to a temperature control line. This enables highly effective temperature control of the grinding bowl and thus of the sample held by the grinding bowl, whereby heat is transferred between the temperature control medium and the grinding bowl via a wall of the heat transfer element when a cold or warm or hot temperature control medium passes through the temperature control line. During grinding operation, an outer side of the cooling plate is in contact with a base surface of the grinding bowl, whereby heat is transferred by conduction via the contact surface of the cooling plate and the base surface of the grinding bowl.

The grinding bowl holder of the known laboratory mill has a holding bracket which is firmly connected to a swing arm of the laboratory mill and which interacts with a horizontally adjustable further holding bracket. By adjusting a clamping screw, the external holding bracket can be braced against an internal holding bracket and thus a grinding bowl can be horizontally braced between the holding brackets.

A coupling element is provided on an outer side of the grinding bowl, which can be coupled or connected to another coupling element on the holding bracket connected to the swing arm. The coupling elements have outer functional surfaces that form coupling geometries and interlock when the grinding bowl is inserted into the grinding bowl holder. When the grinding bowl is braced in the grinding bowl holder, a positive connection is formed between the coupling geometries. The grinding bowl is guided via the coupling geometries when it is inserted into the grinding bowl holder and is held in the exact position on the grinding bowl holder when braced.

### SUMMARY

The task of the present invention is to further develop the laboratory mill known from DE 10 2020 101 523 A1. In particular, it is the task of the invention to provide a laboratory mill which is characterized by homogeneous results during sample treatment, in particular when the sample holder is loaded with several samples and the samples are treated simultaneously during operation of the laboratory mill. Finally, the scope of application of the laboratory mill known from DE 10 2020 101 523 A1 is to be advantageously extended.

In order to solve the aforementioned problem, it is proposed according to the invention in a laboratory mill of the type mentioned at the beginning that several complementary coupling geometries are provided on the sample holder and the holding device for a particularly positive coupling of the sample holder with the holding device, wherein the sample holder can be coupled to the holding device via the coupling geometries in at least two different orientations relative to the axis of rotation and/or the axis of oscillation, and wherein the effective radius of the orbit of at least one sample vessel, in particular the effective radii of the orbits of several sample vessels, can be altered by changing the orientation of the sample holder. The coupling geometries predetermine a specific orientation of the sample holder in the coupled state relative to the holding device.

The term “effective radius of the orbit” describes the distance between an axis of rotation and/or oscillation or swivel axis, about which the sample holder is rotated or oscillates during grinding operation, and a point and/or area of a sample vessel held on the sample holder, in relation to a preferably horizontal plane. By coupling the sample holder as required via coupling geometries arranged at different points on the sample holder, the sample holder can be connected to the holding device in different orientations relative to the axis of rotation and/or axis of oscillation, which leads to a change, namely an increase or decrease, in the effective radius of the orbit of at least one sample vessel held on the sample holder.

The change in the effective radius of the orbit refers to the same, preferably horizontal, viewing plane.

Due to the coupling geometries provided at different positions on the sample holder, the sample holder can be connected to the holding device as required via a first coupling geometry or via a second coupling geometry or a further coupling geometry. By coupling the sample holder to the holding device via different coupling geometries, the distance of radially outer sample vessels and radially inner sample vessels of the sample holder, in relation to a grinding state of the laboratory mill, to the axis of rotation and/or oscillation axis can be changed in order to positively influence the grinding result.

The sample holder can be coupled or connected to the holding device via the multiple coupling geometries on the sample holder with different alignment of the sample holder to the axis of rotation and/or axis of oscillation. By changing the alignment of the sample holder to the axis of rotation and/or oscillation axis and coupling the sample holder to the holding device via a first coupling geometry or via at least one further coupling geometry, the alignment of previously radially inner samples or sample areas and radially outer samples or sample areas also changes.

Preferably, it can be provided that the sample holder has coupling geometries on opposite outer sides, so that it is possible to couple the sample holder to the holding device as required via a first coupling geometry on a first outer side or via a second coupling geometry on a second outer side. Preferably, depending on the coupling, the sample holder can be coupled to the holding device via the first coupling geometry or via the second coupling geometry, preferably rotated by 180° about a transverse axis running transverse to the effective radius. This allows the effective radius of the orbit of at least one sample vessel held in and/or on the sample holder to be changed in order to homogenize the grinding result.

Although the sample holder is preferably designed to hold a plurality of sample vessels, the sample holder can also be designed to hold only one sample vessel.

Changing the alignment of the sample holder in the coupling state relative to the axis of rotation and/or oscillation changes the kinematics of a sample within a sample vessel of the sample holder. Changing the alignment of the sample holder to the axis of rotation and/or oscillation also influences the kinematics within a sample vessel. For example, it is possible that radially outer areas of a sample within a sample vessel of the sample holder are arranged closer to the axis of rotation and/or oscillation or are arranged radially inwards after changing the orientation of the sample holder relative to the axis of rotation and/or oscillation, and correspondingly radially inner areas of the sample within the sample vessel are arranged further away from the axis of rotation and/or oscillation or are arranged radially outwards after changing the orientation of the sample holder. As a result, the effective radius of the orbits of different areas within a sample vessel changes and thus also the kinematics of radially inner areas and radially outer areas of the sample inside the sample vessel.

In particular, it is thus possible to adjust the kinematics of samples located radially inside the sample holder during operation of the laboratory mill and samples located radially outside by changing the orientation of the sample holder. For this purpose, the operation of the laboratory mill can be interrupted after half the treatment time or grinding time, for example, and the sample holder is removed from the holding device or decoupled from the holding device. The sample holder is then rotated, preferably by 180°, and reconnected or coupled to the holding device via the coupling geometries with this new alignment to the axis of rotation and/or swivel axis. If, on the other hand, the sample holder is held and carried along on the holding device over the entire grinding time with the same alignment of the samples to the axis of rotation and/or swivel axis, the kinematics of the laboratory mill cause the radially inner samples and the radially outer samples to move on orbits with unequal effective radii and thus possibly unequal treatment results are achieved during sample treatment.

Changing the orientation of the sample holder can also be advantageous if it only holds one sample or a plurality of samples that are moved on the same orbit around the rotation and/or swivel axis during the mill operation. A change of orientation can then be provided in particular to ensure a homogeneous treatment or grinding result of the sample within a sample vessel.

In addition to the coupling of the sample holder to the holding device via the coupling geometries, the holding device can have a clamping device in order to brace the sample holder in and/or on the holding device, for example in the manner described in DE 10 2020 101 523 A1. When the sample holder is braced in and/or on the holding device, a positive coupling or connection of the coupling geometries can then be formed, so that the sample holder is fixed on the holding device.

Functional surfaces of the coupling geometry on the sample holder and functional surfaces of the coupling geometry on the holding device are complementary. During coupling, complementary functional surfaces of the coupling geometries can interact and, in particular, be interlocked. For example, complementary coupling geometries can be joined together in the manner of a dovetail connection, in particular when the sample holder is inserted into the holding device from above.

The coupling geometries can be designed and have corresponding functional surfaces in such a way that the functional surfaces can be inserted into each other with sufficient play. The coupling geometries can then be used to guide the sample holder. After the interlocking and before the sample holder is braced in and/or on the holding device via a clamping means of the holding device, the functional surfaces of the coupling geometries can move relative to each other. This makes it possible to insert the coupling geometry of the sample holder into a complementary coupling geometry of the holding device in a simple manner from above when inserting the sample holder into the holding device.

When the sample holder is braced in and/or on the holding device, the functional surfaces of the coupling geometries are then moved towards each other so that a positive connection occurs and the specimen holder is fixed in the exact position on the holding device in the coupled state.

Preferably, in relation to the operation of the laboratory mill or in the coupling state of the sample holder, several coupling geometries provided on the sample holder are located on orbits with different effective radii. Depending on which coupling geometry of the sample holder is used to couple the sample holder to the holding device, a different alignment of the sample holder relative to the holding device and thus also relative to the axis of rotation and/or oscillation about which the sample holder is moved during operation of the laboratory mill can be achieved.

In particular, the sample holder can be coupled to the holding device via the coupling geometries provided on the sample holder in two different orientations of the sample holder relative to the axis of rotation and/or oscillation, which are preferably rotated by 180° relative to each other. After the rotation of the alignment and the coupling, the previously radially inner samples or sample areas are then radially outer and vice versa. To change the effective radius of the orbit of a sample vessel, in particular the effective radii of the orbits of several sample vessels, the coupling geometries on the sample holder can accordingly be designed to be rotationally symmetrical about a first central plane of the sample holder, in particular about a central plane of the sample holder extending transversely to the radial through the rotation and/or swivel axis.

For a change in the left-right orientation of the sample holder relative to the radial through the rotation and/or swivel axis, a further rotationally symmetrical design of the coupling geometries on the sample holder about a second center plane of the sample holder can be provided, in particular wherein the second center plane extends orthogonally to the first center plane, further in particular wherein the second center plane intersects the rotation and/or swivel axis. The term “left-right alignment of the sample vessel” refers here to the position of the sample vessel to the left or right of the radial through the swivel and/or rotation axis about which the holding device is rotated and/or oscillates during operation of the laboratory mill. As a result, the sample holder can be coupled to the holding device, in particular inserted into the holding device, in a total of four different orientations due to the rotationally symmetrical design around two central planes running orthogonally to each other.

Preferably, the sample holder has coupling geometries on both radial outer sides, which can be coupled with at least one coupling geometry on the holding device in order to change the effective radius of the orbit of a sample vessel, in particular the effective radii of the orbits of several sample vessels, by changing the alignment of the sample holder in mill operation. Alternatively, however, it is also possible for the sample holder to have a coupling geometry on just one outer side, whereby two complementary coupling geometries can then be provided on the holding device and whereby each coupling geometry of the holding device is opposite a radial outer side of the sample holder. In this embodiment, the sample holder can thus also be coupled to the holding device as required with different alignment to the axis of rotation and/or swivel axis.

Furthermore, an embodiment in which the sample holder has at least one coupling geometry on opposite radial outer sides and the holding device has several complementary coupling geometries is not excluded, whereby at least one complementary coupling geometry on the holding device is assigned to each coupling geometry on a radial outer side of the sample holder. In the coupling state, the sample holder is then coupled to the holding device on two opposite outer sides of the sample holder in each case via complementary coupling geometries of the sample holder and the holding device.

For a simplified design of the sample holder, it is expedient if two coupling geometries are formed identically on radially opposite outer sides of the sample holder. However, an embodiment in which the sample holder has different coupling geometries on radially opposite outer sides, which interact with correspondingly different coupling geometries of the holding device that are complementary to the respective coupling geometry of the sample holder, is not excluded.

As in the embodiment shown in DE 10 2020 101 523 A1, the sample holder can, in the coupled state, rest at least in some areas against a heat transfer element, in particular a plate-shaped heat transfer element, connected to a temperature control medium line, and in particular rest on the heat transfer element. A cooling plate can be provided on the holding device, on which the sample holder rests and is indirectly cooled or heated by the cooling plate. The temperature structure can be homogenized by rotating the sample holder 180° around the radial or by changing the left-right orientation of the samples. For this purpose, the sample holder preferably has two even axial opposite flat sides, which can rest against the cooling plate depending on the rotation of the sample holder.

At least one coupling element, preferably detachably attached to the sample holder or the holding device, can be provided to form a coupling geometry. Alternatively, the coupling geometry can also be formed by a structure of a base body of the sample holder or the holding device. Functional surfaces of the coupling geometry can be subject to increased wear so that the coupling element can be replaced easily when a certain state of wear is reached. The coupling element can be made of hardened stainless steel, for example, to reduce the tendency to wear.

It is advantageous in terms of design and with regard to equipping the sample holder with one or more sample vessels if the sample holder has two half parts that are preferably hinged to each other, in particular where each half part is designed to hold a plurality of reaction and/or grinding vessels. A hinged connection can preferably be provided on the outside of the outer edges of the half parts. The half parts may have openings or recesses for receiving at least one sample vessel, but preferably for receiving a plurality of sample vessels. Each half part can be formed by a material block made of a solid material into which the openings are made, in particular in the form of through-holes.

At least one coupling element that forms a coupling geometry can be attached to each half part of the sample holder. The coupling geometry on the holding device can also be formed by a coupling element that is attached to the holding device. Alternatively, coupling geometries can also be formed by functional surfaces of the half parts themselves or by functional surfaces of the holding device, for example formed on a holding bracket of the holding device.

Due to the division of the sample holder into two parts with hinged half parts, the sample holder has an interrupted coupling geometry on the radial outer sides of the half parts. Each half part therefore preferably has a coupling element and/or a coupling geometry on both radial outer sides. Two coupling elements or coupling geometries provided on the same radial outer sides of the half parts can interact with a coupling element or a coupling geometry of the holding device when coupling the sample holder to the holding device.

In a closed state of the sample holder, the half parts can be positively connected at least in some areas, whereby the half parts can have corresponding positive locking means connected to the half parts for this purpose, or the half parts themselves have projections, recesses or other geometric designs that join together positively when the sample holder is closed.

In an open state of the sample holder, the half parts can be swung apart, whereby in the open state of the sample holder, the reaction vessels can be loaded via the flat sides of the half parts that are on the inside and facing each other in the closed state of the sample holder.

At least one mechanical separation lock can be provided to make it more difficult or prevent unintentional opening of the sample holder by swinging the half parts apart after the sample holder has been closed. For example, latching and/or spring means can be provided to hold the half parts together when the sample holder is closed.

Preferably, the sample holder consists of two half parts that are designed as identical components. The mirrored structure enables the sample holder to be manufactured cost-effectively. The mirrored structure also applies in particular to the design and arrangement of the functional surfaces forming the coupling geometry(ies) of the sample holder.

The half parts can preferably be made of a material with high thermal conductivity, such as aluminum, for improved heat transfer.

### BRIEF DESCRIPTION OF THE DRAWINGS

The drawings show an embodiment of the invention, which is described below.

FIG. 1 is a perspective partial view of a laboratory mill according to the invention with a sample holder inserted into a holding device of the laboratory mill in an oblique view from above.

FIG. 2 is a perspective view of the sample holder from FIG. 1 in a closed state.

FIG. 3 is a perspective view of the sample holder from FIG. 2 in an open state.

FIG. 4 is a perspective partial view of the laboratory mill from FIG. 1, showing the sample holder connected to the holding device in a coupled state.

FIG. 5 is a further perspective partial view of the laboratory mill from FIG. 1, showing the sample holder connected to the holding device in a coupled state.

FIG. 6 is a side view of the laboratory mill from FIG. 1, partially cut away.

FIG. 7 is a top view of the holding device and the sample holder accommodated in the holding device of the laboratory mill shown in FIG. 1.

### DETAILED DESCRIPTION

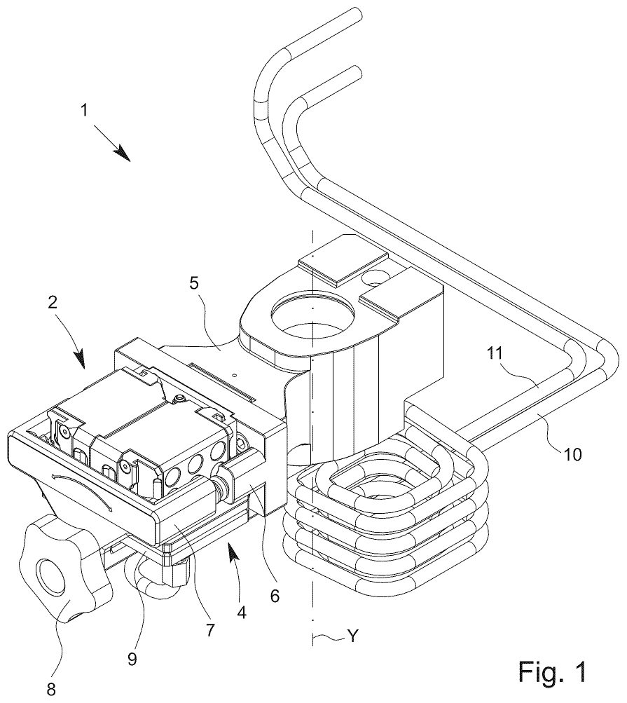

FIGS. 1 to 7, a laboratory mill 1 is shown, which is designed as a laboratory vibrating mill. The laboratory mill has a sample holder 2 for holding a plurality of sample vessels 3. To receive the sample vessels 3, a corresponding number of receiving spaces for receiving the sample vessels 3 are provided in half parts 19, 20 of the sample holder 2.

The sample holder 2 is inserted into a holding device 4, which is arranged to oscillate about an oscillating axis Y (FIGS. 1, 5), for holding and carrying along the sample holder 2 during operation of the laboratory mill 1. The holding device 4 is connected to a swing arm 5 of the laboratory mill 1 and is moved along with the swing arm 5 during mill operation.

The laboratory mill 1 shown in FIG. 1 only in a partial view has two holding devices 4 for sample holders 2 that perform circular arc-shaped oscillations in a horizontal position, whereby FIG. 1 shows only one holding device 4 with a sample holder 2 held therein as an example. The basic structure of the laboratory mill 1 is already described in DE 10 2020 101 523 A1. Reference is made to the disclosure content of the aforementioned publication.

The design of the holding device 4 is also already known from DE 10 2020 101 523 A1. By referring to DE 10 2020 101 523 A1, the disclosure content of the aforementioned publication is included in the disclosure content of the present description of the figures.

The holding device 4 has a holding bracket 6 that is firmly connected to the swing arm 5 and interacts with another horizontally adjustable holding bracket 7. By adjusting a tensioning screw 8, the outer holding bracket 7 can be braced against the inner holding bracket 6 and thus the sample holder 2 can be braced horizontally between the holding brackets 6 and 7.

Temperature control, i.e. cooling or heating, of the sample holder 2 is possible via a temperature control device not shown. The temperature control takes place via a cooling plate 9 and is already described in DE 10 2020 101 523 A1; reference is made to the disclosure content of DE 10 2020 101 523 A1.

To transport a temperature control medium, which can be liquid or gaseous, from a stationary part of the laboratory mill 1 to the holding device 4 and to discharge it from the holding device 4 to the stationary part, the holding device 4 is connected to two temperature control lines 10, 11. In each case, one of the two temperature control lines 10, 11 is provided for the supply of a gaseous or liquid temperature control medium, in particular liquid nitrogen, to the holding device 4, while the other of the two temperature control lines 10, 11 is provided for the discharge.

The sample holder 2 is designed to hold sample vessels 3, in particular for biological samples. For temperature-sensitive biological samples, active temperature control via the temperature control of the sample holder 2 with the cooling plate 9 is advantageous. Temperature control offers the possibility of regulating discrete temperatures within narrow limits. Various cooling and heating options are available for this purpose.

In the embodiment shown, the sample holder 2 is designed to hold a total of 18 sample vessels 3. In this case, nine sample vessels 3 can be accommodated or held in each half part 19, 20. It is understood that the sample holder 2 can also be designed to hold a larger number or a smaller number of sample vessels 3.

The kinematics of the laboratory mill 1 causes radially inner samples and radially outer samples to lie on orbits with unequal effective radii r1, r3.

As can be seen from FIG. 5, the radially outer sample vessels 3, which are held on or in the sample holder 2, lie on an orbit with the effective radius r1, the radially central sample vessels lie on an orbit with the effective radius r2 and the radially inner sample vessels lie on an orbit with the effective radius r3—in relation to an identical, preferably horizontal plane.

The oscillation or swivel movement of the holding device 4 and thus of the sample holder 2 during operation of the laboratory mill 1 about the rotation or swivel axis Y is indicated by the arrow 12 in FIG. 5.

The term “effective radius” refers to the same horizontal viewing plane in which the effective radii r1, r2 and r3 lie. The effective radii r1, r2 and r3 therefore describe a different distance of the radially outer sample vessels 3, the radially central sample vessels 3 and the radially inner sample vessels 3 to the axis of rotation or swivel axis Y when the sample holder 2 is coupled to the holding device 4.

Complementary coupling geometries are formed on the sample holder 2 and the holding device 4. In the embodiment shown, the sample holder 2 has coupling geometries on opposite outer sides. The sample holder 2 can be coupled to the holding device 4 via the coupling geometries with different orientations of the sample holder 2 or with different distances of the opposite outer sides of the sample holder from the axis of rotation and/or oscillation or swivel axis Y.

Due to the possibility of coupling or connecting the sample holder 2 to the holding device 4 as required via the coupling geometries provided on different outer sides, the alignment of the sample holder 2 to the axis of rotation and/or oscillation or swivel axis Y or the distance of the respective outer side of the sample holder 2 during grinding operation from the axis of rotation and/or oscillation or swivel axis Y and thus the effective radius r1 of the orbit of the radially outer sample vessels 3 and the effective radius r3 of the orbit of the radially inner sample vessels 3 can be changed.

In the embodiment shown in FIG. 5, the effective radius r1 describes the distance between a central axis M1 of the radially outer sample vessels 3 and the axis of rotation or swiveling Y, the central axis M1 corresponding to a central longitudinal axis through the radially outer sample vessels 3 or running parallel to this central longitudinal axis. Accordingly, the effective radius r3 describes the distance between a central axis M3 of the radially inner sample vessels 3 and the rotation or swivel axis Y, whereby the central axis M3 coincides with the central longitudinal axis of the radially inner sample vessels 3 held on the sample holder 2 or runs parallel to this central longitudinal axis. Depending on the effective radius r1, r2 and r3, the kinematics of the samples change during grinding operation.

The effective radius r2 describes the distance between a central axis M2 of the radially centered sample vessels 3 held on the sample holder 2, which preferably does not change when the orientation of the sample holder 2 is rotated relative to the rotational and/or swivel axis Y. However, the kinematics of the samples inside the centrally arranged sample containers 3 are also equalized during grinding operation by changing the alignment of the sample holder 2 relative to the axis of rotation and/or swivel axis Y. If, starting from the alignment of the sample holder shown in FIG. 5, the sample holder 2 is decoupled from the holding device 4 and connected to the complementary coupling geometry on the holding device 4 rotated by 180°, this results in the sample vessels 3 located radially on the outside in FIG. 5 being arranged radially on the inside after the alignment of the sample holder 2 has been changed during the subsequent grinding operation and, conversely, the sample vessels 3 located radially on the inside before the alignment change according to FIG. 5 being located radially on the outside after the alignment change. This means that the kinematics of the samples inside the sample vessels 3 can be compared by changing the orientation of the sample holder 2 once or several times over the duration of a grinding process relative to the axis of rotation or swivel axis Y during sample grinding.

As can also be seen from FIG. 5, the coupling geometries offer the possibility of connecting the sample holder 2 either to the radially outer outside or to the radially inner outside with a complementary coupling geometry formed radially on the inside of the holding device 4.

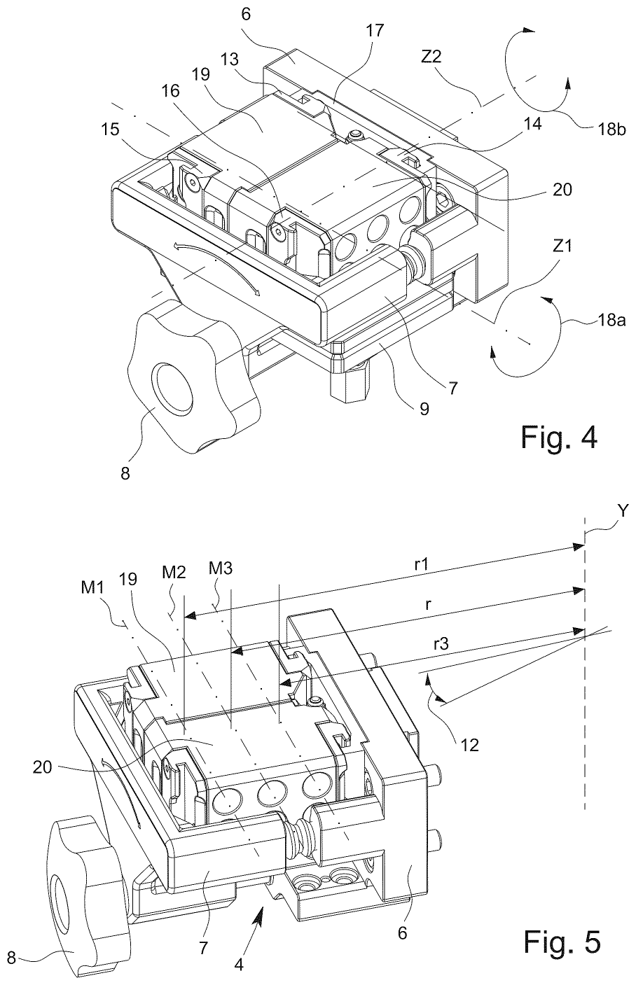

In the embodiment shown, the coupling geometries allow the sample holder 2 to be connected to the holding device 4 in the form of a dovetail joint. Other coupling geometries are possible. The coupling geometries on the sample holder 2 are formed by a total of four coupling elements 13-16 arranged on different radial outer sides of the sample holder 2. In the embodiment shown (FIG. 4), the radially inner coupling elements 13, 14, i.e. those adjacent to the swivel axis Y, are coupled to a coupling element 17, which is attached to the holding bracket 6 firmly connected to the swing arm 5. The coupling elements 15, 16 provided on the opposite outside of the sample holder 2, on the other hand, are not coupled.

The coupling geometries are formed by complementary functional surfaces of the coupling elements 13-17. The functional surfaces of the coupling elements 13, 14 and 15, 16, which are each arranged on the same outer side of the sample holder 2, can be fitted into one another with the complementary functional surface of the coupling element 17 provided on the holding device 4 by forming undercuts, when the sample holder 2 is inserted into the holding device 4 from above.

The coupling geometries are dimensioned in such a way that the interacting functional surfaces can be inserted into each other with lateral play. When inserting the sample holder 2 into the holding device 4, the sample holder 2 is guided via the coupling geometries on the coupling elements 13, 14, 17 during the vertical movement. When the holding brackets 6, 7 are then braced with the tensioning screw 8, the sample holder 2 is braced with the radially outer holding bracket 7 in a radial direction to the swivel axis Y, so that a form closure is created between the functional surfaces. As a result, the sample holder 2 is held or braced precisely in position on the holding device 4.

The coupling elements 13, 14 provided on the same radially inner outside of the sample holder 2 on the one hand and the coupling elements 15, 16 provided on the same radially outer outside of the sample holder 2 on the other hand lie on orbits with different effective radii.

As can also be seen from FIG. 4, a rotationally symmetrical arrangement of the coupling elements 13-16 and a rotationally symmetrical design of the coupling surfaces on the sample holder 2 about a central axis of the sample holder 2 extending transversely to the radial direction can be provided. Due to a rotationally symmetrical arrangement and design of the coupling geometries, the sample holder 2 can be inserted into the holding device 4 and coupled to the holding device 4 with different radial alignment of the opposite outer sides of the sample holder 2 to the swivel axis Y. This makes it possible, by rotating the sample holder 2 about a central transverse axis Z1 and coupling the sample holder 2 to the holding device 4 via the coupling geometries provided on different outer sides, to adjust the kinematics in particular of the radially inner samples and the radially outer samples, whereby, for example, the sample holder 2 is released from the holding device 4 after half the grinding time of a grinding process and is then reinserted into the holding device 4 to continue the grinding process after a rotation of preferably 180° about the transverse axis Z1 and the grinding process is continued.

The possibility of coupling the sample holder 2 with different radial outer sides to the radially inner holding bracket 6 as required is shown schematically in FIG. 4 by the arrow 18a.

Another embodiment is not excluded, in which corresponding coupling geometries are formed on both holding brackets 6, 7, whereby, for example, each holding bracket 6 can have a coupling element 17 adjacent to the sample holder 2. The sample holder 2 can then only have a complementary coupling geometry on one radial outer side, for example formed by two coupling elements 13, 14 or 15, 16 of the type shown in FIG. 4.

It is to be understood that the design of the coupling geometries shown or the contours of the functional surfaces forming the coupling geometry on the coupling elements 13-17 are selected by way of example.

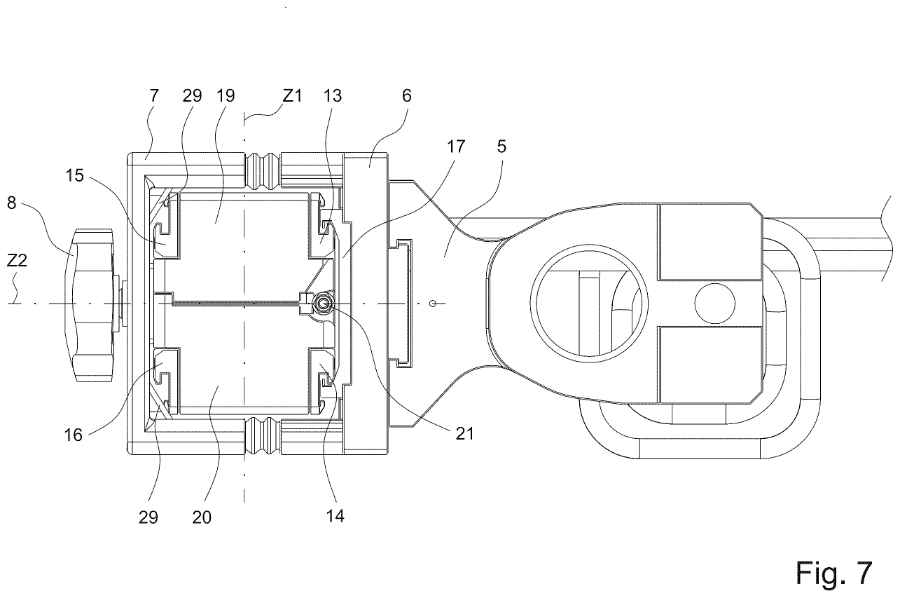

As can also be seen from FIG. 4, a rotationally symmetrical design of the coupling geometries on the sample holder 2 and the holding device 4 about a second central plane is also provided in order to change the left-right orientation of the samples by rotating the sample holder 2 about the central radial longitudinal axis or mirror axis Z2. This is shown in FIG. 4 by the arrow 18b. The mirror axis Z2 preferably intersects the joint axis of the joint 21 (FIG. 7) and the swivel axis Y (FIG. 5).

In a top view or cross-sectional view, the functional surfaces that form the coupling geometries are arranged mirror-symmetrically to the transverse axis Z1 and the mirror axis Z2 (FIG. 4). This means that the sample holder 2 can be inserted into the holding device 4 in a total of four different orientations and coupled to the holding device 4 via the coupling geometries.

The coupling elements 13, 14 on the radially inner outside of the sample holder 2 and the coupling elements 15, 16 on the radially outer outside of the sample holder 2 are of the same design, so that all coupling geometries are of the same design. This results in a simple design, whereby the coupling geometries on both radially outer sides of the sample holder 2 can be coupled or inserted as required into the complementary coupling geometry on the holding device 4 or on the holding bracket 6.

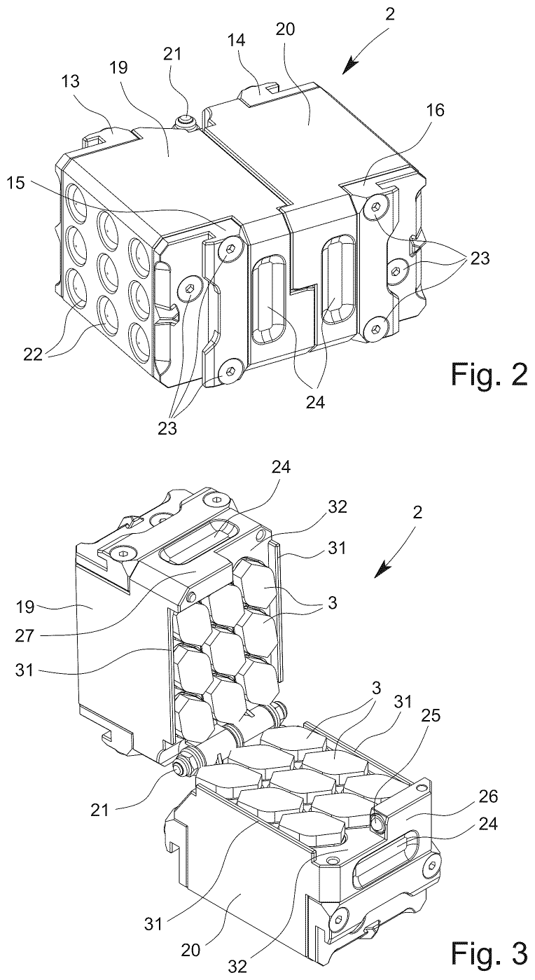

In the embodiment shown (FIG. 2, FIG. 3), the sample holder 2 has two half parts 19, 20 which are preferably hinged to one another, whereby each half part 19, 20 can be designed, for example, to hold nine sample vessels 3 and has corresponding receiving spaces for the sample vessels 3. The arrangement of the receiving spaces for the sample containers 3 is to be understood as exemplary.

The half parts 19, 20 are connected via a joint 21 so that the half parts 19, 20 can be swung apart from the closed position shown in FIG. 2 into an open position shown in FIG. 3 in order to transfer the sample holder 2. In the swung-apart state, sample vessels 3 can be inserted into openings 22 of the half parts 19, 20 via facing, inner flat sides of the half parts 19, 20. The sample vessels 3 can have lids, whereby each sample vessel 3 then rests on the half parts 19, 20 via the edge of the lid and is held on the inside.

The hinged connection of the half-parts 19, 20 or the multi-part design of the sample holder 2 requires an interruption of the coupling geometry on the radially outer sides of the sample holder 2. For this purpose, each half-part 19, 20 has at least one coupling element 13, 15 or 14, 16 on the radially inner outer side and one on the radially outer outer side. As described above, depending on the orientation of the sample holder 2, the two radially inner coupling elements 13, 14 of the half parts 19, 20 or the two radially outer coupling elements 15, 16 of the half parts 19, 20 interact with the coupling element 17 or are coupled with the coupling element 17 as described above.

Each half part 19, 20 is made from a block of solid material, in particular from a material with high thermal conductivity, for example aluminum. In the coupled state, when the sample holder 2 is inserted into the holding device 4 and braced in the holding device 4, the half parts 19, 20 lie against the cooling plate 9 on the underside. This enables very precise temperature control of the sample holder 2, whereby a controlled temperature change of the sample holder 2 is possible in a short time by changing the temperature of the cooling plate 9. By rotating the sample holder 2 around a radial axis or the axis Z2 (FIG. 4), the temperature structure can be homogenized easily.

In addition, the coupling elements 13-17 are preferably detachably connected to the half parts 19, 20 or the holding bracket 6 via screws 23. The coupling elements 13-17 can be made of a hardened material, in particular hardened stainless steel, so that the functional surfaces of the coupling geometries wear less easily.

The half parts 19, 20 are designed as identical components. The mirrored structure means that the sample holder 2 can be manufactured cost-effectively.

On the radial outer side of the half parts 19, 20 facing away from the joint 21, handle recesses 24 can be provided for the fingers of a user in order to simplify the opening of the sample holder 2.

The half-parts 19, 20 can have a latching means to prevent unintentional opening of the sample holder 2. In the embodiment shown, for example, a resilient pressure piece 25 is provided on a projection 26 of the first half-part 20, which resiliently engages in a complementary opening in a projection 27 of the second half-part 19 and serves as a separation lock when the half-parts 19, 20 are folded together and the sample holder 2 is closed.

In addition, edge bars 31 are formed on the inner sides of the half parts 19, 20 facing each other, which protrude from the inner flat sides 32 of the half parts 19, 20 by at least the height of the lids of the sample vessels 3. After loading with the sample vessels 3, the half parts 19, 20 can be folded on top of each other, whereby the edge bars 31 of the half parts 19, 20 are used to create essentially closed side surfaces of the sample holder 2. The projections 26, 27 then lie against the adjacent flat sides 32, so that the radial outer surface of the sample holder 2 on the side of the sample holder 2 facing away from the joint 21 adjacent to the insertion area of the half parts 19, 20 for the sample vessels 3 is also essentially closed.

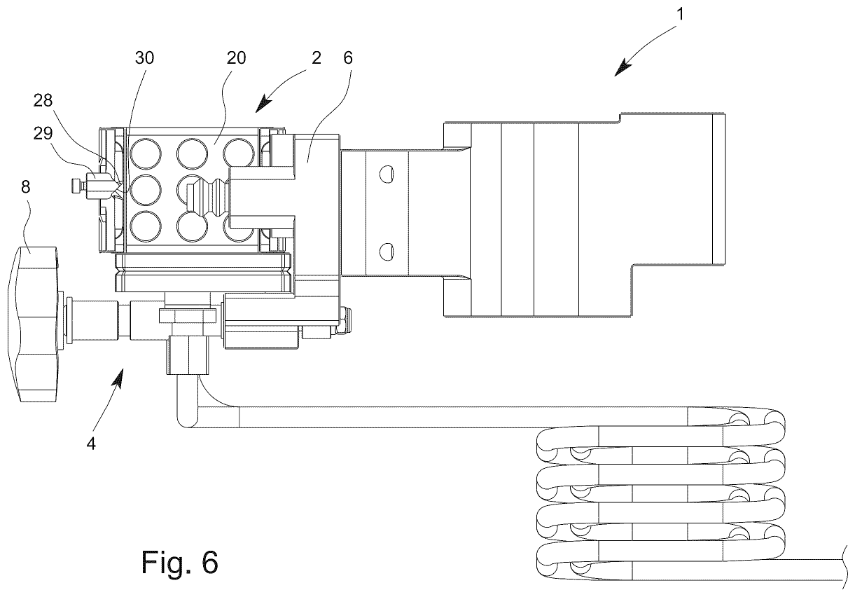

The sample holder 2 can have inclinations 28 (FIG. 6), which interact with inclinations 30 on clamping pieces 29, whereby the clamping pieces 29 are arranged on the inside of the external holding bracket 7. The clamping pieces 29 are arranged in the corner areas of the holding bracket 7 and, when the sample holder 2 is braced horizontally in the holding device 4, cause the sample holder 2 to be automatically pressed downwards against the cooling plate 9 by deflecting the force. This improves the heat transfer through heat conduction between the half parts 19, 20 and the cooling plate 9.

### LIST OF REFERENCE SYMBOLS

1 Laboratory mill
2 Sample holder
3 Sample vessel
4 Holding device
5 Swing arm
6 Holding bracket
7 Holding bracket
8 Tensioning screw
9 Cooling plate
10 Temperature control line
11 Temperature control line
12 Arrow
13 Coupling element
14 Coupling element
15 Coupling element
16 Coupling element
17 Coupling element
18a Arrow
18b Arrow
19 Half part
20 Half part
21 Joint
22 Opening
23 Screw
24 Handle recess
25 Pressure piece
26 Projection
27 Projection
28 Inclination
29 Clamping piece
30 Inclination
31 Edge bar

1. A laboratory mill comprising:
at least one sample holder for receiving at least one sample vessel; and
at least one holding device, which is rotatable about an axis of rotation and/or arranged to oscillate about an axis of oscillation, for holding and carrying along the at least one sample holder during operation of the laboratory mill;
wherein the at least one sample vessel is moved on an orbit with an effective radius during operation of the laboratory mill;
wherein complementary coupling geometries are provided on the at least one sample holder and the at least one holding device for a positive coupling of the at least one sample holder to the at least one holding device; and
wherein the at least one sample holder can be coupled to the at least one holding device via the coupling geometries in at least two different orientations relative to the axis of rotation and/or the axis of oscillation in order to change the effective radius of the orbit of the at least one sample vessel.

2. The laboratory mill according to claim 1, wherein several coupling geometries on the at least one sample holder are located on orbits with different effective radii.

3. The laboratory mill according to claim 1, wherein, for a change in the effective radius of the orbit of the at least one sample vessel, a design of the coupling geometries on the at least one sample holder which is rotationally symmetrical about a first center plane of the at least one sample holder is provided.

4. The laboratory mill according to claim 1, wherein the at least one sample holder has a plurality of coupling geometries on radially opposite outer sides.

5. The laboratory mill according to claim 1, wherein the at least one sample holder has two half parts connected to one another in a hinged manner, each of the half parts designed to accommodate a plurality of sample vessels.

6. The laboratory mill according to claim 1, wherein at least one coupling element detachably fastened to the at least one sample holder or the at least one holding device is provided, wherein the at least one coupling element forms a coupling geometry of the coupling geometries.

7. The laboratory mill according to claim 5, wherein each half part has at least one coupling element on each radial outer side and wherein coupling elements arranged on an identical radial outer side of the half parts are coupled in the coupling state of the at least one sample holder to a coupling geometry of the at least one holding device.

8. The laboratory mill according to claim 5, wherein the half parts are designed as identical components.

9. The laboratory mill according to claim 1, wherein the at least one sample holder is made of aluminum and/or has at least one base body made of aluminum for receiving the at least one sample vessel.

10. A sample holder for a laboratory mill with the features according to claim 1.

11. The laboratory mill according to claim 1, wherein the at least one sample holder is configured for receiving a plurality of sample vessels.

12. The laboratory mill according to claim 11, wherein the at least one sample holder is made of aluminum and/or has at least one base body made of aluminum for receiving the plurality of sample vessels.

13. The laboratory mill according to claim 11, wherein the at least one sample holder is configured for receiving reaction vessels for small sample volumes in the milliliter range.

14. The laboratory mill according to claim 11, wherein the plurality of sample vessels are moved on orbits with different effective radii.

15. The laboratory mill according to claim 14, wherein the at least one sample holder can be coupled to the at least one holding device via the coupling geometries in at least two different orientations relative to the axis of rotation and/or the axis of oscillation in order to change the effective radii of the orbits of the plurality of sample vessels.

16. The laboratory mill according to claim 1, wherein the at least one holding device is connected to a swing arm of the laboratory mill and moves with the swing arm during operation of the laboratory mill.

17. The laboratory mill according to claim 1, wherein the laboratory mill is a laboratory vibrating mill.

18. The laboratory mill according to claim 3, wherein the first center plane extends transversely to the radial through the axis of rotation and/or the axis of oscillation.

19. The laboratory mill according to claim 4, wherein the plurality of coupling geometries are of the same design.

20. The laboratory mill according to claim 7, wherein the coupling geometry of the at least one holding device is a common coupling element of the holding device.
